(19) United States
(12) Patent Application Publication
(10) Pub. No.: US 2015/0199315 A1
(43) Pub. Date: Jul. 16, 2015

(54) SYSTEMS AND METHODS FOR ANIMATING COLLABORATOR MODIFICATIONS

(71) Applicant: Andrew Alexander Grieve, Waterloo (CA)

(72) Inventor: Andrew Alexander Grieve, Waterloo (CA)

(73) Assignee: Google Inc., Mountain View, CA (US)

(21) Appl. No.: 13/372,257

(22) Filed: Feb. 13, 2012

(51) Int. Cl. G06T 13/00; G06F 3/0484; G06F 17/21

(52) U.S. Cl. CPC G06F 17/24; G06F 17/212; G06F 3/04842

(57) ABSTRACT

Systems and methods for animating a collaborator modification are disclosed herein that utilize duration information associated with the modification in order to depict the timing associated with the modification.

### BACKGROUND OF THE INVENTION

This disclosure generally relates to collaborative electronic document processing applications, and more specifically to animating collaborator modifications made to an electronic document.

Conventional electronic document processing applications allow users to create electronic documents containing text, images, graphics, multimedia, and other types of data. Some applications are used in a local environment, such as on a single user's computer, while other applications are shared on a network with multiple users. For example, two authors may use a web-based drawing application to collaborate on a shared electronic drawing.

Remote collaboration between multiple users on a shared electronic document can be unsatisfying and frustrating for users who concurrently edit the document. Network latency can cause delays in the transmission and reception of modifications made to the document between each user. As a result, a first user may create a modification with particular timing parameters (e.g. draw a line in 0.1 second), but a second user's application on the receiving end may animate the modification with substantially different parameters (e.g. too quickly) or not animating the modification at all. This result is undesirable if it occurs often because it prevents useful feedback between users of the application.

### SUMMARY OF THE INVENTION

Thus, a need exists in the art for animating a collaborator modification to accurately depict the timing associated with the modification. Accordingly, systems and methods for animating a collaborator modification are disclosed herein that utilize duration information associated with the modification in order to depict the timing associated the modification.

According to one aspect, the present disclosure relates to a method of communicating a user modification to a collaborative document in a computer application. A first computer detects and stores the user modification. Next, the first computer stores duration information corresponding to the time spent by a user to make the user modification. Then, the first computer transmits modification data indicative of the user modification and the duration information over a network to a second computer for animation of the modification.

According to another aspect, the present disclosure relates to a method of animating a user modification entered at a first computer on to a collaborative document in a computer application executing on a second computer. The second computer receives from the first computer over a computer network modification data indicative of the user modification and duration information corresponding to the time spent by a user to make the user modification. Next, the second computer renders on to the collaborative document the user modification via an animation derived based on the modification data, wherein timing parameters associated with the animation are determined based the duration information.

According to another aspect, the present disclosure relates to a system for communicating a user modification to a collaborative document in a computer application. The system includes a processor and a memory. The memory stores computer executable instructions, which when executed by the processor cause the processor to detect and store the user modification and to store duration information corresponding to the time spent by a user to make the user modification. In addition, the computer executable instructions, when executed by the processor cause the processor to transmit modification data indicative of the user modification and the duration information over a network to a computer for animation of the modification.

According to another aspect, the present disclosure relates to a system for animating a user modification to a collaborative document. The system includes a processor and a memory. The memory stores computer executable instructions, which when executed by the processor cause the processor to receive from a first computer over a network modification data indicative of the user modification and duration information corresponding to the time spent by a user to make the user modification. In addition, the computer executable instructions when executed by the processor cause the processor to render on to the collaborative document the user modification via an animation derived based on the modification data, wherein timing parameters associated with the animation are determined based the duration information.

### BRIEF DESCRIPTION OF THE DRAWINGS

Further features of the present disclosure, its nature and various advantages, will be apparent upon consideration of the following detailed description, taken in conjunction with the accompanying drawings, in which like reference characters refer to like parts throughout, and in which:

FIG. 1 is a block diagram of a system for animating collaborator modifications, according to an illustrative embodiment.

FIG. 2 is a block diagram of a drawing application for animating collaborator modifications, according to an illustrative embodiment.

FIG. 3 is depicts a collection of screenshots of the drawing application of FIG. 2 for animating collaborator modifications, according to an illustrative embodiment.

FIG. 4 is a flowchart showing a method of storing and transmitting modification data indicative of a collaborator modification, according to an illustrative embodiment.

FIG. 5 is a flowchart showing a method of receiving modification data indicative of a user modification and duration information and animating the modification based on the data and the duration information, according to an illustrative embodiment.

FIG. 6 is a flowchart showing a method of storing and transmitting modification data indicative of a drawing stroke made to a collaborative drawing using the system of FIG. 1, according to an illustrative embodiment.

FIG. 7 is a flowchart showing a method of receiving modification data indicative of the drawing stroke of FIG. 6 and animating the stroke, according to an illustrative embodiment.

### DESCRIPTION OF CERTAIN ILLUSTRATIVE EMBODIMENTS

To provide an overall understanding of the present disclosure, certain illustrative embodiments will now be described, including systems and methods for animating a collaborator modification. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

Overview

Aspects of the present disclosure relate to systems and methods for animating a collaborator modification are disclosed herein that utilize duration information associated with the modification in order to depict the timing of the modification.

System Description

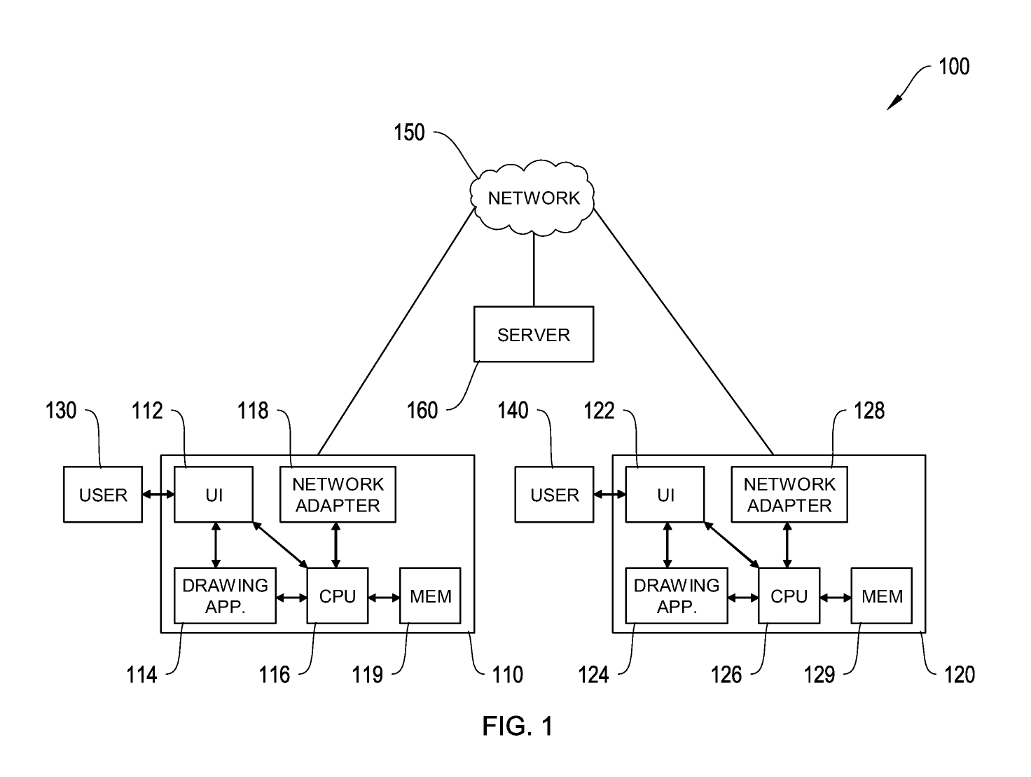

FIG. 1 is a block diagram of a system 100 for animating collaborator modifications, according to an illustrative embodiment. The system 100 includes computing devices 110 and 120, a server 160, and a network 150 that connects the computing devices 110 and 120 and the server 160. A first user 130 interacts with the computing device 110, and a second user 140 interacts with the computing device 120. The computing devices 110 and 120 are any type of computer device such as desktop computers, laptops, tablets, or smart phones.

The computing device 110 includes a user interface 112, a drawing application 114, a central processing unit (CPU) 116, a network adapter 118, and a memory 119. Similarly, the computing device 120 includes a user interface 122, a drawing application 124, a CPU 126, a network adapter 128, and a memory 129. The memory 119 and the memory 129 each include a volatile memory as well as a non-volatile memory for storing computer-executable instructions for a computer application, such as the drawing application 114 or the drawing application 124. Examples of non-volatile memory include magnetic drives, integrated circuit memory (e.g., flash memory), or other non-volatile storage media known in the art. In order for the CPU 116, for example, to execute the instructions stored in the non-volatile memory of the memory 119, the instructions are loaded into the volatile memory of the memory 119. Examples of volatile memory include device RAM or cache memory incorporated into the CPU 116 or CPU 126. At various times the drawing application 114, for example, reads data from and writes data to both the non-volatile memory and the volatile memory of the memory 119. Similarly, at various times the drawing application 124 reads data from and writes data to both the non-volatile memory and the volatile memory of the memory 129.

Examples of the user interface 112 and the user interface 122 include devices such as keyboards, mice, touchscreens, or tablet pens.

The network adapter 118 and the network adapter 128 are any type of network interface, such as an Ethernet card, a wireless adapter, a Bluetooth adapter, or a cellular radio. The network 150 is any network, such as an intranet, the Internet, a local area network (LAN), a wide area network (WAN), a telephone network, or a combination of networks.

In some implementations, the drawing application 114 running on the computing device 110 and the drawing application 124 running on the computing device 120 are copies of the same application. The drawing application 114 and the drawing application 124 respectively allow the first user 130 and the second user 140 to collaboratively create and edit a document, such as a drawing.

The server 160 stores a master copy of the document while the drawing application 114 and the drawing application 124 each store a separate local cached copy of the document. When the first user 130 modifies the document in the drawing application 114, the drawing application 114 updates the local cached copy of the document. Next, the drawing application 114 transmits modification data indicative of the modification through the network 150 via the network adapter 118 to the server 160. The server 160 updates the master copy of the document to comply with the modification. Then, the server 160 pushes out the modification to other collaborators, such as the second user 140. For example, the server 160 transmits the modification data indicative of the modification to the drawing application 124 at the computing device 120. The drawing application 124 updates its local cached copy of the document to reflect the modification, and it animates the modification to present to the second user 140. Similarly, if the second user 140 is the one to modify the document, then the foregoing steps are performed in reverse order.

In some implementations, the system 100 is peer-to-peer, e.g., the drawing application 114 and the drawing application 124 transmit modification data directly to each other rather than through the server 160. In some implementations, the drawing application 114 or the drawing application 124 will delay sending modification data until several modifications have been made to allow for batch transmission of multiple modifications.

Although the system 100 depicts two computing devices and one server, it will be clear to one skilled in the art to apply the principles disclosed herein to systems with any combination of computing devices and servers.

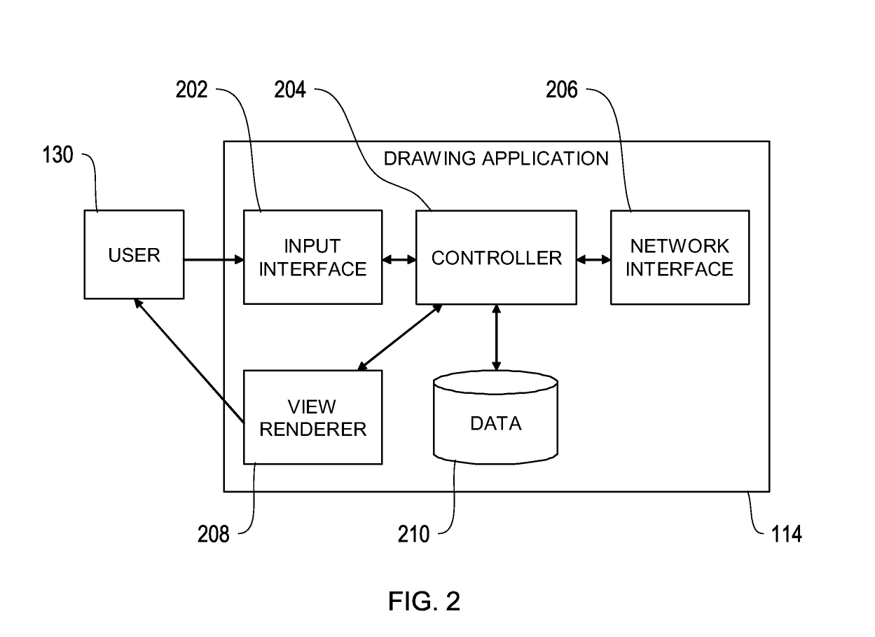

FIG. 2 is a block diagram of a drawing application, such as the drawing application 114, for animating collaborator modifications, according to an illustrative embodiment. The drawing application 114 includes an input interface 202, a controller 204, a network interface 206, a view/renderer 208, and data 210. The first user 130 interacts with the drawing application 114 to create, view, and edit a document in collaboration with other users, such as the second user 140.

The input interface 202 receives input from the first user 130, processes the input, and passes the input to the controller 204. Examples of the user interface 202 include a mouse pointer, a paintbrush tool, or software buttons, such as buttons simulating a color palette. The controller 204 manages the functions and the data of the drawing application 114. The data 210 stores various data, such as a local cached copy of a document processed by the drawing application 114. The view/renderer 208 displays to the first user 130 a visual presentation of the document. The view/renderer 208 renders modifications made locally by the first user 130, and it also animates modifications to the document made by other users. The network interface 206 communicates with applications running on other devices, such as the server 160 or the computing device 120, to transmit and receive modification data and other information.

When the first user 130 modifies the document processed by the drawing application 114, the input from the first user 130 is received by the input interface 202, processed, and passed to the controller 204. The controller 204 stores modification data indicative of the modification, such as point coordinates, vector lengths, line thickness, or line color, as described later in detail. The controller 204 also stores timing parameters associated with the modification that are suitable for animating the modification to collaborators, as described later in detail. Next, the controller 204 applies the modification to the local cached copy of the document stored in the data 210. The controller 204 also instructs the view/renderer 208 to update the visual presentation of the document to reflect the modification to the first user 130. Finally, the controller 204 instructs the network interface 206 to transmit to the server 160 the modification data indicative of the modification and the timing parameters.

When another user, such as the second user 140, remotely makes a modification to the document, the network interface 206 receives modification data indicative of the modification and timing parameters from the server 160. The controller 204 processes the data and applies the modification to the local cached copy of the document stored in the data 210. The controller 204 also generates an animation of the modification based on the modification data and the timing parameters and instructs the view/renderer 208 to render the animation to the first user 130. The first user 130 can submit input to the input interface 202 while the animation occurs.

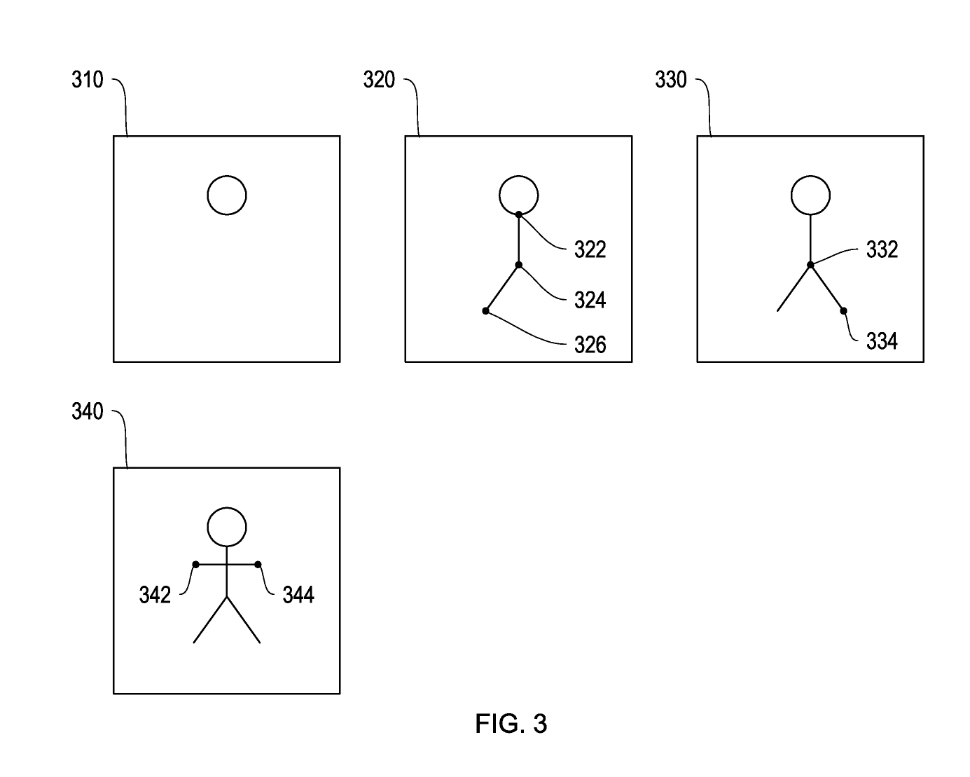

FIG. 3 depicts a collection of screenshots of the drawing application 114 for animating collaborator modifications, according to an illustrative embodiment. For example, in FIG. 3, the users 130 and 140 collaboratively edit a drawing using the system 100 as described in FIG. 1. The first user 130 runs the drawing application 114 at the computing device 110, and the second user 140 runs the drawing application 124 at the computing device 120.

A screenshot 310 depicts a view of the drawing application 114 presented to the first user 130. The screenshot 310 shows the drawing in an initial state with a circle on a white background. The first user 130 decides to modify the drawing to show a stick figure person using the circle as a head. A screenshot 320 depicts the drawing after the first user 130 has added a drawing stroke representing a torso and leg. Points 322 and 326 correspond to the start point and end point of the stroke. A point 324 corresponds to an intermediate point along the stroke where the first user 130 changed the direction of the stroke.

The drawing application 114 stores data representing the points 322, 324, and 326 as well as color, thickness, and other information. The drawing application 114 also stores a relative timestamp corresponding to each point. For example, the first user 130 started at the point 322, drew the line segment from the point 322 to the point 324 in 0.1 seconds, and drew the line segment from the point 324 to the point 326 in 0.4 seconds. In this example, the drawing application 110 would store a timestamp of 0 for the point 322, a timestamp of +0.1 seconds for the point 324, and a timestamp of +0.5 seconds for the point 326.

Then, the drawing application 114 transmits modification data indicative of the drawing stroke and the timestamps to the server 160 over the network 150. The server 160 pushes the modification data to the drawing application 124 used by the second user 140 at the computing device 120.

Similarly, screenshots 330 and 340 depict the drawing after the first user 130 has added additional drawing strokes representing a second leg and a pair of arms respectively. The points 332 and 334 correspond to the second leg, and the points 342 and 344 correspond to the arms. The drawing application 114 will also transmit to the server 160 modification data representing the drawing stroke made between the points 332, 334, 342, and 344 and relative timestamps corresponding to each point. The server 160 will also push the modification data to the drawing application 124 used by the second user 140 at the computing device 120.

In some implementations, the drawing application 110 stores absolute timestamps corresponding to each point.

In some implementations, the drawing application 114 will transmit modification data immediately after a drawing stroke is made. In other implementations, the drawing application 114 will delay transmission of modification data for a period of time, for example, to allow for transmission of a batch of drawing strokes or to comply with a predetermined transmission schedule.

At the computing device 120, the drawing application 124 uses the received modification data to animate the drawing strokes made by the first user 130. For example, for the drawing stroke depicted in the screenshot 320, the drawing application 124 will create an animation based on the relative timestamps corresponding to each point in the stroke. The animation starts with a rendering of the line segment starting at the point 332 and ending at the point 324 that is scaled to take 0.5 seconds to complete. The animation finishes with a rendering of the line segment starting at the point 324 and ending at the point 326 that is scaled to take 0.4 seconds to complete. Hence, the speed of the animation will correspond with substantial fidelity to the speed of the actual drawing stroke made by the user 130 as shown in the screenshot 320.

In some implementations, the drawing application 124 delays the animation of a drawing stroke for a period of time. For example, the drawing application 124 may wait until it has buffered sufficient modification data in order to avoid network delays or other potential performance problems associated with the animation.

Sometimes, modification data may arrive at the drawing application 124 in a different order than it was sent from the drawing application 114. The drawing application 124 will animate drawing strokes in the order that it receives the modification data indicative of the strokes. In implementations using absolute timestamps, the drawing application 124 will delay animation for a predetermined period of time to wait for more modification data to arrive. When the predetermined period of time passes, the drawing application 124 will animate the received drawing strokes in a chronological order derived from the absolute timestamps associated with the strokes.

In some implementations, the drawing application 124 will scale the animation speed of a drawing stroke to occur faster or slower than the actual time that was taken to draw the stroke. For example, in some implementations, if the drawing application 124 suddenly receives a large amount of modification data when an animation is already in progress, it will speed up the animation so that the animation will complete within a predetermined amount of time, e.g. 1 second. In various implementations, the drawing application 124 will animate multiple drawing strokes from different collaborators simultaneously if, for example, the modification data corresponding to the strokes arrive approximately at the same time or if the timestamps for the drawing strokes overlap for a period of time.

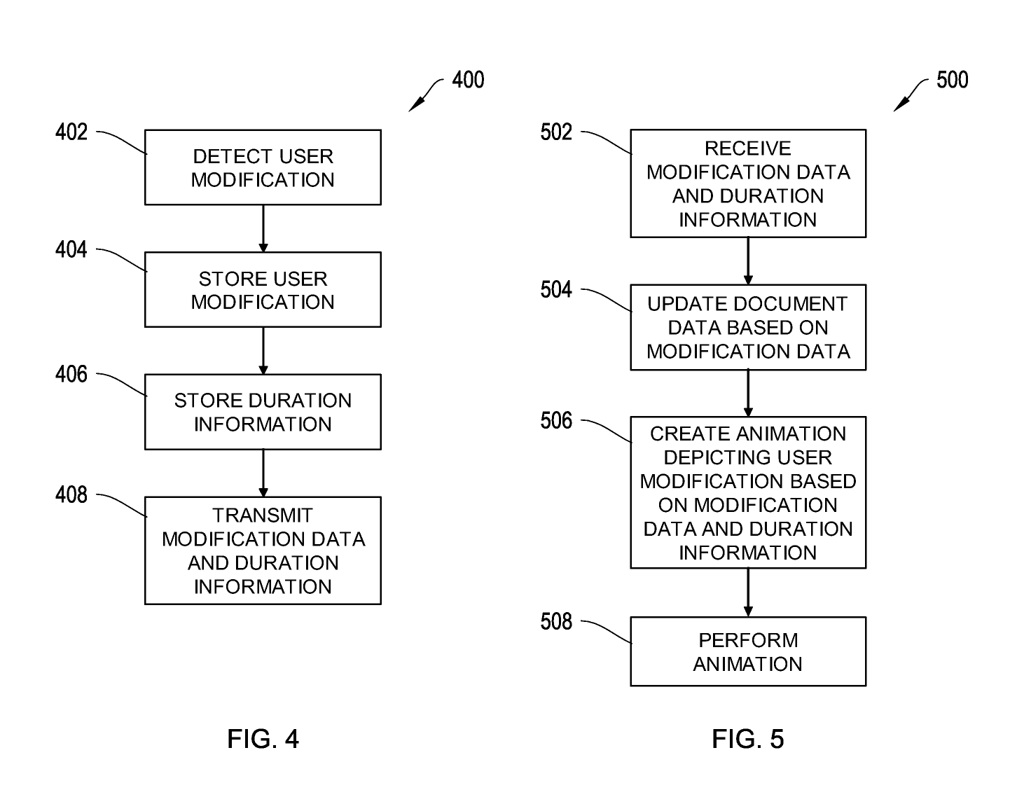

FIG. 4 is a flowchart showing a method 400 of storing and transmitting modification data indicative of a collaborator modification, according to an illustrative embodiment. First, an application, such as the drawing application 114, running on a first computing device detects a user modification to a collaborative document being processed by the application (step 402). In some implementations, the user modification includes a drawing stroke added to a collaborative drawing. For example, the drawing stroke may include a first point corresponding to the start of the stroke and a second point corresponding to the end of the stroke. The drawing stroke may also include one or more intermediate points associated with information indicative of the drawing stroke. For example, an intermediate point can correspond to a change of direction, a change in drawing speed, or a change of stroke thickness of the drawing stroke. In some implementations, the user modification includes an erasure of a region of the collaborative document. For example, the erasure can include a plurality of points that correspond to the erased region.

Next, the application stores the user modification (step 404), and the application stores duration information corresponding to the time spent by the user to make the user modification (step 406). In some implementations, the duration information includes a plurality of timestamps, as described earlier. For example, if the user modification is a drawing stroke, the duration information may include a timestamp associated with each point in the stroke, such as the first point, the second point, or an intermediate point as described earlier.

The application then transmits modification data indicative of the user modification and the duration information over a network to a second computing device for animation (step 408). As described earlier, in some implementations, the second computing device may include a server configured to transmit the modification data and the duration information to a third computing device for animation of the modification. The server is configured to store and manage a centralized copy of the collaborative document. For example, the server may provide version control functions for the collaborative document, such as tracking user modifications submitted by multiple users, resolving conflicts between the user modifications, and updating the collaborative document to incorporate the modifications. In some implementations, the server may merge multiple user modifications together into one user modification or simplify a user modification before transmitting modification data indicative of the modification and duration information associated with the modification to the third computing device for animation of the modification.

FIG. 5 is a flowchart showing a method 500 of receiving modification data indicative of a user modification and duration information and animating the modification based on the data and the duration information, according to an illustrative embodiment. First, an application, such as the drawing application 124, receives modification data indicative of a user modification to a collaborative document being processed by the application and duration information associated with the user modification (step 502).

Next, the application updates the document to reflect the user modification based on the modification data (step 504).

The application creates an animation depicting the user modification based on the modification data and the duration information, where the timing parameters associated with the animation are determined based on the duration information (step 506). In some implementations, the application adjusts the speed of the animation to fit a timescale. In some implementations, the application may determine the timescale based on the duration information, or the timescale may be predetermined. For example, as described earlier, the speed of the animation can correspond proportionally or exactly with the speed of the user modification, or the application may adjust the speed of the animation so that the animation completes in a predetermined period of time, e.g. 1 second.

The application then performs the animation (step 508). In some implementations, the application delays the animation for a period of time. For example, the application may delay the animation in order to wait for more modification data to arrive. In some implementations, the period of time is predetermined. For example, the period of time may be predetermined based on network conditions, such as the amount of the network congestion.

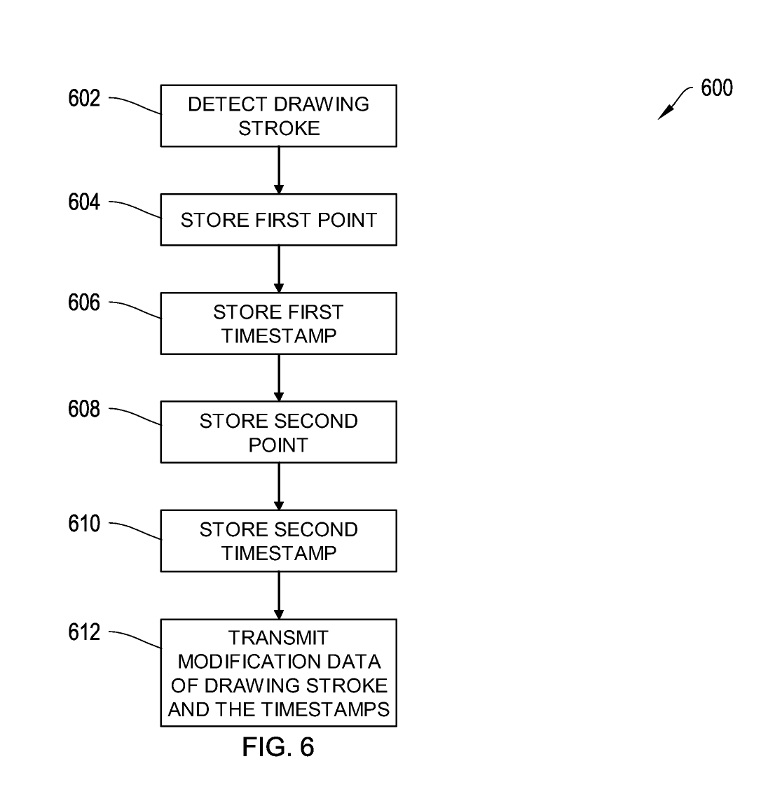

FIG. 6 is a flowchart showing a method 600 of storing and transmitting modification data indicative of a drawing stroke made to a collaborative drawing using the system 100, according to an illustrative embodiment.

In the system 100, the drawing application 114 at the first computing device 110 detects a drawing stroke made by the user 130 to the collaborative drawing depicted in the screenshots of FIG. 3 (step 402). In this example, the modification is the drawing stroke containing the points 332 and 334 depicted in the screenshot 330 of FIG. 3.

The drawing application 114 stores the first point 332 (step 604). The drawing application 114 also stores a first relative timestamp associated with the first point 332 (step 606). Then, the drawing application 114 stores the second point 334 (step 608) and also a second relative timestamp associated with the second point 334 (step 610).

Then, the drawing application 114 transmits the modification data indicative of the drawing stroke (e.g. the points, stroke thickness, and color) and the timestamps to the server 160 to send to other collaborators, such as the user 140 (step 612).

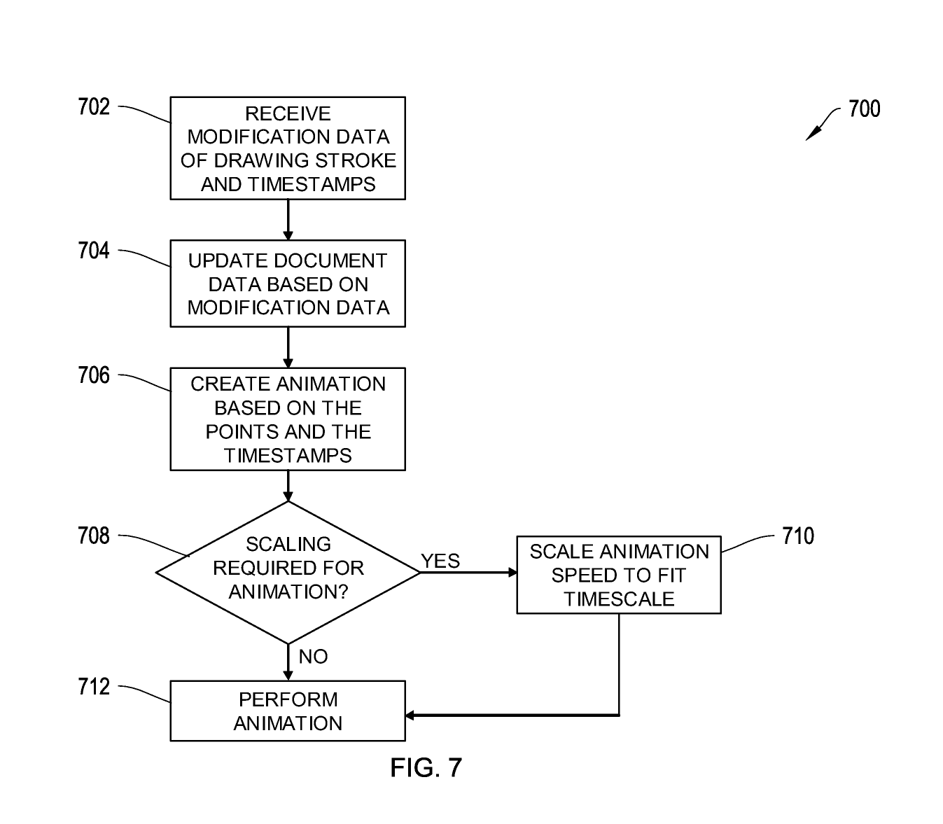

FIG. 7 is a flowchart showing a method 700 of receiving modification data indicative of the drawing stroke of FIG. 6 and animating the stroke, according to an illustrative embodiment.

To continue the example in FIG. 6, in the system 100, the drawing application 124 at the second computing device 120 receives modification data indicative of the drawing stroke and the timestamps (step 702). As described above, the user modification in this example is the drawing stroke depicted in the screenshot 330 of FIG. 3.

The drawing application 124 updates its local copy of the drawing to reflect the drawing stroke (step 704). The drawing application 124 also creates an animation depicting the drawing stroke based on the modification data (e.g. the points, line thickness, color) and the timestamps (step 506).

Then, the drawing application 124 determines if the animation speed requires scaling (step 708). For example, the drawing application 124 will scale the animation speed if there are many pending drawing strokes from collaborators that need to be animated. If scaling is required, then the drawing application 124 will scale the animation speed to fit a timescale (step 710). By scaling the animation speed, the drawing application 124 ensures that the animation will complete in a suitable amount of time in order to provide a responsive experience to the user. Finally, regardless of whether or not the animation speed is scaled, the drawing application 124 performs the animation for the user 140 at the appropriate speed (step 712).

While various embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in practicing the invention. It is intended that the following claims define the scope of the invention and that methods and structures within the scope of these claims and their equivalents be covered thereby.

1. A method of communicating a user modification to a collaborative document in a computer application, the method comprising:
detecting and storing by a first computer the user modification;
storing by the first computer duration information corresponding to the time spent by a user to make the user modification; and
transmitting by the first computer modification data indicative of the user modification and the duration information over a network to a second computer for animation of the modification in the collaborative document, wherein the animation is rendered on a display of the second computer and the animation is based on a timing parameter of the duration information that is adjusted, by the second computer, to fit a timescale.

2. The method of claim 1, wherein the duration information comprises a plurality of timestamps.

3. The method of claim 2, wherein the user modification comprises a drawing stroke comprising a first point corresponding to the start of the modification and a second point corresponding to the end of the modification.

4. The method of claim 3, wherein the duration information comprises a first timestamp associated with the first point and a second timestamp associated with the second point.

5. The method of claim 3, wherein the drawing stroke comprises an intermediate point occurring after the first point and before the second point.

6. The method of claim 5, wherein the intermediate point corresponds to a change of direction, change of drawing speed, or change of stroke thickness of the drawing stroke.

7. The method of claim 5, wherein the duration information comprises an intermediate timestamp associated with the intermediate point.

8. The method of claim 2, wherein the user modification comprises an erasure of a region of the collaborative document comprising a plurality of points corresponding to the erased region.

9. The method of claim 1, wherein the transmitting by the first computer comprises transmitting the modification data and the duration information over a network to a server configured to transmit the modification data and the duration information to the second computer for animation of the modification.

10. A method of animating a user modification entered at a first computer on to a collaborative document in a computer application executing on a second computer, comprising:
receiving, at the second computer from the first computer over a computer network, modification data indicative of the user modification and duration information corresponding to the time spent by a user to make the user modification; and
rendering on to the collaborative document, by the second computer, the user modification via an animation derived based on the modification data, wherein the second computer determines timing parameters associated with the animation based on the duration information and adjusts the timing parameters to fit a timescale.

11. (canceled)

12. The method of claim 10, wherein the second computer is configured to determine the timescale based at least on the duration information.

13. The method of claim 10, wherein the timescale is predetermined.

14. The method of claim 10, wherein the second computer is configured to delay the animation by a period of time.

15. The method of claim 14, wherein the period of time is predetermined.

16. The method of claim 14, wherein the second computer is configured to determine the period of time based at least on network conditions.

17. A system for communicating a user modification to a collaborative document in a computer application, the system comprising:
a processor,
a memory storing computer executable instructions, which when executed by the processor cause the processor to:
detect and store the user modification;
store duration information corresponding to the time spent by a user to make the user modification; and
transmit modification data indicative of the user modification and the duration information over a network from a first computer to a second computer for animation of the modification in the collaborative document, wherein the animation is rendered on a display of the second computer and is based on a timing parameter of the duration information that is adjusted, by the second computer, to fit a timescale.

18. The system of claim 17, wherein the duration information comprises a plurality of timestamps.

19. The system of claim 18, wherein the user modification comprises a drawing stroke comprising a first point corresponding to the start of the modification and a second point corresponding to the end of the modification.

20. The system of claim 18, wherein the duration information comprises a first timestamp associated with the first point and a second timestamp associated with the second point.

21. The system of claim 19, wherein the drawing stroke comprises an intermediate point occurring after the first point and before the second point.

22. The system of claim 21, wherein the intermediate point corresponds to a change of direction, change of drawing speed, or change of stroke thickness of the drawing stroke.

23. The system of claim 21, wherein the duration information comprises an intermediate timestamp associated with the intermediate point.

24. The system of claim 18, wherein the user modification comprises an erasure of a region of the collaborative document comprising a plurality of points corresponding to the erased region.

25. The system of claim 17, wherein the transmitting by the processor comprises transmitting the modification data and the duration information over a network to a server configured to transmit the modification data and the duration information to the computer for animation of the modification.

26. A system for animating a user modification to a collaborative document, comprising:
a processor,
a memory storing computer executable instructions, which when executed by the processor cause the processor to:
receive from a first computer over a network modification data indicative of the user modification and duration information corresponding to the time spent by a user to make the user modification, wherein the modification data and duration information are received by a second computer; and
render on to the collaborative document the user modification via an animation derived based on the modification data, wherein the second computer determines timing parameters associated with the animation based on the duration information and adjusts the timing parameters to fit a timescale.

27. (canceled)

28. The system of claim 26, wherein the processor is configured to determine the timescale based at least on the duration information.

29. The system of claim 26, wherein the timescale is predetermined.

30. The system of claim 26, wherein the processor is configured to delay the animation by a period of time.

31. The system of claim 30, wherein the period of time is predetermined.

32. The system of claim 30, wherein the processor is configured to determine the period of time based at least on network conditions.

33. A method of communicating a drawing stroke comprising a first point and a second point made to a collaborative document in a computer application, comprising:
detecting and storing by a first computer the drawing stroke;
storing by the first computer a first timestamp corresponding to the first point and a second timestamp corresponding to the second point; and
transmitting by the first computer modification data indicative of the drawing stroke and the timestamps over a network to a second computer for animation of the drawing stroke in the collaborative document, wherein the animation is rendered on a display of the second computer and is based on a timing parameter, derived from the first and second timestamps, that is adjusted, by the second computer, to fit a timescale.

34. A system for communicating, from a first computer to a second computer, a drawing stroke comprising a first point and a second point made to a collaborative document, comprising:
a processor,
a memory storing computer executable instructions, which when executed by the processor cause the processor to:
detect and store the drawing stroke;
store a first timestamp corresponding to the first point and a second timestamp corresponding to the second point; and
transmit modification data indicative of the drawing stroke and the timestamps over a network to the second computer for animation of the drawing stroke in the collaborative document, wherein the animation is rendered on a display of the second computer and is based on a timing parameter, derived from the first and second timestamps, that is adjusted, by the second computer, to fit a timescale.
